(19) United States
(12) Patent Application Publication
(10) Pub. No.: US 2006/0168592 A1
(43) Pub. Date: Jul. 27, 2006

(54) System and method for many-to-many information coordination and distribution

(75) Inventors: Joyce Andrews, Downers Grove, IL (US); Gerald Eisner, Naperville, IL (US); Walter W. Gruchala, Naperville, IL (US)

Correspondence Address: MICHELE ZARINELLI;c/o WEST CORPORATION, 11808 MIRACLE HILLS DRIVE, MSW11 - LEGAL, OMAHA, NE, 68154, US

(73) Assignee: Intrado Inc.

(21) Appl. No.: 11/011,220

(22) Filed: Dec. 14, 2004

(51) Int. Cl. G06F 9/46; G06F 9/44

(52) U.S. Cl. 719/318

(57) ABSTRACT

A hazard information coordination system is provided with intelligent routing to enhance the distribution of information from multiple information sources to a plurality of destinations. Routing is performed based on data values and associated intelligence that determines what data is relevant to which users. User preferences, geographical location, local environment, current activities, and planned activities help a decision support system determine what data is relevant for each user. Thus, decision support systems are preferably provided with situational awareness, context awareness, and forecasting capabilities.

### FIELD OF THE INVENTION

The present invention relates generally to intelligent routing of communication among a plurality of information sources and a plurality of destinations, and, more specifically, to implementing intelligent routing in a hazard information coordination system.

### BACKGROUND OF THE INVENTION

The majority of news-distribution services implement a broadcast (i.e., one-to-many) format for disseminating information to the public. Because these services are not designed for any particular user, they lack any notion of user context. For example, a broadcast service (such as the National Weather Service) typically accumulates amount of local data to produce broadcast information that is generally important to the public at large, but not particularly relevant to an individual on a local scale. Similarly, traffic reporting services seldomly provide enough information to be particularly relevant to an individual on a local scale. Furthermore, news-broadcasting services rarely correlate different information feeds, and thus provide limited situational awareness and forecasting capabilities for the majority of news recipients.

In contrast, context events provided by a smart environment are typically not handled by global services. Rather, context applications usually reside on a local machine (e.g., a PDA, laptop, PC, etc.) and must filter out a large amount of irrelevant information. Thus, from each user's perspective, the channel providing the flow of information is not used efficiently. While broadcast channels represent a bandwidth-efficient solution for distributing static information on a global scale, a broadcast architecture becomes excessively inefficient when employed for highly interactive and/or highly bandwidth-intensive network communications.

Therefore, there is a problem in the art that there is a wealth of information available but no way to filter and deliver the information to those who need it.

### SUMMARY OF THE INVENTION

This problem is solved and a technical advancement is achieved in the art by a system and method that provides centralized data processing and routing to connect a plurality of data collectors with a plurality of destinations (i.e., data receivers). Intelligent routing is used to evaluate received data, sort it and route the data to selected destinations based on data values. A plurality of parameters, including, but not limited to, user preferences are employed in a selection process to determine what data gets routed to which users. Embodiments of the invention are particularly useful with respect to a broad range of applications.

For example, some embodiments of the invention are particularly useful in a hazard information coordination system (for example, a traffic management and alert system) where timely and location-specific warnings must be provided. Such systems include (but are not limited to) warning motorists of hazardous conditions, optimizing route planning with respect to multiple external conditions (such as traffic, road conditions, and weather), correlating data sources for nowcasting and forecasting applications, personalizing information services, dynamic rescheduling, and coordinating motorist actions with emergency response activities.

Several method and apparatus embodiments of the invention provide for evaluating and routing data collected from a plurality of data sources relative to at least one data-evaluation metric. A computer program embodiment includes an intelligent routing source code segment that evaluates collected data, and then routes data to predetermined destinations based on the value of the data. Similarly, separate evaluating and routing source code segments may be provided.

Exemplary embodiments of the invention provide many benefits and advantages, including (but not limited to) reducing required data bandwidth to client-side applications, enabling relational processing of a large variety of data types, and providing decision support systems with improved situational awareness, context awareness, and forecasting capabilities.

### BRIEF DESCRIPTION OF THE DRAWINGS

A more complete understanding of this invention may be obtained from a consideration of this specification taken in conjunction with the drawings, in which:

FIG. 1 is a block diagram of an exemplary hazard information coordination system in accordance with this invention adapted to perform many-to-many data communications;

FIG. 2 illustrates exemplary method and apparatus embodiments of the invention;

FIG. 3 is a block diagram that illustrates a functional implementation of a decision support system corresponding to apparatus and method embodiments of the invention;

FIG. 4 illustrates a decision support system implemented within a hazard information coordination system and configured to serve a plurality of subscribers;

FIG. 5 is a functional embodiment of a decision support system implemented in a hazard information coordination system; and

FIG. 6A illustrates a software embodiment of the invention; and

FIG. 6B illustrates an alternative software embodiment of the invention.

### DETAILED DESCRIPTION

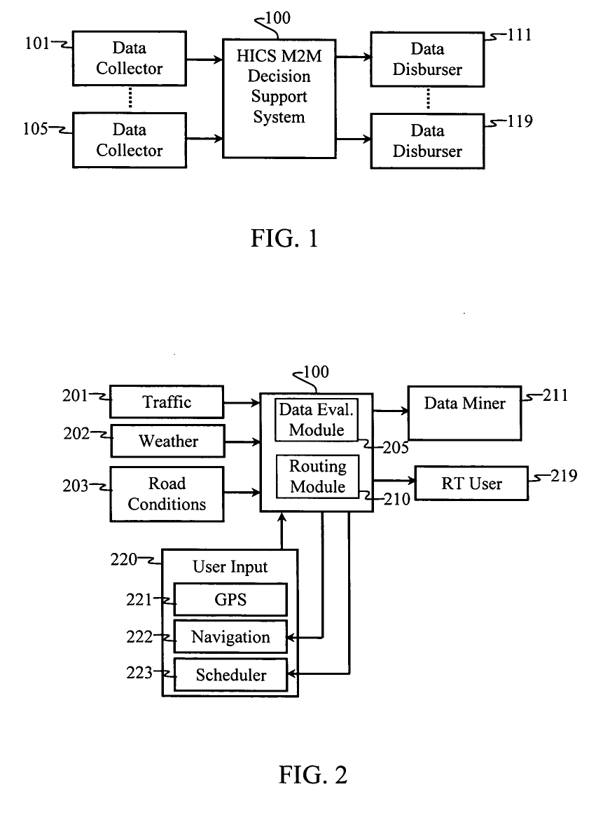

FIG. 1 illustrates an overview block diagram of an exemplary embodiment of this invention. A many-to-many (M2M) hazard information coordination system (HICS) decision support system 100 is coupled to a plurality of data collectors 101-109 and a plurality of data disbursers 111-119. Decision support system 100 is adapted to receive a plurality of different data types and/or data formats from data collectors 101-109. Decision support system 100 is configured to evaluate the data from data collectors 101-109 and then, based on the data evaluation, decision support system 100 associates routing instructions to data-bearing messages intended for one or more destinations. Specifically, decision support system 100 is adapted to recognize and evaluate different data formats and data values and select recipients of particular data messages from a plurality of possible destinations. Thus, unlike a conventional router, which routes a message based on attached routing instructions, decision support system 100 can evaluate data, generate at least one data-bearing message therefrom, and select at least one recipient (i.e., user) for the at least one data-bearing message based on how relevant the data may be to the recipient.

Decision support system 100 can perform intelligent routing based on data formats, data values, or both. Intelligent routing typically includes routing the data, derivatives of the data (i.e., processed data) or both to at least one of a plurality of destinations via the data disbursers 111-119. However, intelligent routing may also comprise any of various data-processing operations, including (but not limited to) combining data sets, correlating data, generating user-device (e.g., navigation control system) control messages from data, categorizing data and/or data values, summarizing data for reporting purposes, data mining, compression, encryption, and employing predetermined data values, ranges, and/or relationships to trigger a predetermined operation. Decision support system 100 may employ a relevance estimation function configured to estimate how relevant certain data is to particular recipients. Such relevance estimation functions are well known in the art and are therefore not discussed further. One skilled in the art will understand which relevance estimation function to use for a specific application after studying this specification.

Data collectors 101-109 may include sources of local data, regional data or both. For example, data collectors 101-109 may include individual sensors or other local data sources. Data collectors 101-109 may include data collators or other types of regional data gathering systems, data processing systems or both.

Data disbursers 111-119 may include data distribution service providers, such as media servers, paging service providers, broadcast systems, local-cast systems, and other application-specific service providers and networks. Furthermore, data disbursers 111-119 may comprise individual client-side systems, including displays, media players, and other client-side devices configured with data interfaces.

For example, data disbursers 111-119 may include wireless communication devices, radios, automobile navigation systems, computers, and the like. In some embodiments of the invention, data disbursers 111-119 may include public-notification systems, such as electronic highway signs, warning signals, public-address systems, and emergency callback systems. In other embodiments, data disbursers 111-119 may include traffic-control devices, such as traffic lights, electronic speed-limit signs, railroad signals, and the like.

Some embodiments of the invention may provide for conditioning disbursement of the data for commercial distribution. For example, data disbursers 111-119 may include a subscription server (not shown) adapted to format data received from decision support system 100 for distribution to customers paying for (e.g., subscribing to) information services. Thus, real-time data may be sold to passenger-transportation companies, freight companies, delivery services, school districts, and other groups who can benefit from information that assists in the dynamic routing of assets. Similarly, compiled data and/or processed (e.g., mined) data may be sold to organizations that can use it for planning purposes. For example, Automatic Collision Notification (ACN) data can used to better improve the design of roads and interchanges. Collected data can also be used for predictive modeling for changes in traffic signaling and law enforcement.

FIG. 2 illustrates exemplary method and apparatus embodiments of the invention. An M2M HICS decision support system 100 is coupled to a traffic data source 201, a weather data source 202, and a road conditions data source 203. Data sources 201-203 represent examples of external data sources that can characterize the local environment relative to at least one user 220. Data sources for decision support system 100 may also include user input 220 (such as GPS data source 221, navigation data source 222, and scheduling data source 223). Decision support system 100 is adapted to receive a plurality of different data types and/or data formats from the data sources 201-203 and 221-223. Decision support system 100 processes and routes received data relative to the data type and, optionally, relative to one or more data values.

Decision support system 100, according to one exemplary embodiment, includes one or more software modules or algorithms, such as data-evaluation module 205 and routing module 210. Data-evaluation module 205 is adapted to evaluate at least one of the data type and the data value(s). Data-evaluation module 205 is adapted to perform one or more data-processing functions (e.g., summing, averaging, correlating, editing, filtering, generating a statistical characterization, etc.) before and/or after evaluating the data. Thus, processed data are evaluated. Similarly, evaluated data is processed prior to routing.

Evaluation of data may include comparing data values to predetermined thresholds, historical values, other data values, etc. The resulting data values are then used in a routing decision process performed by routing module 210 to select data for routing and allocate which destinations (e.g., users) receive the data. Exemplary embodiments of the invention may combine the data-evaluation module 205 and a routing module 210 into a single module or algorithm.

Routing module 210 is adapted to route raw and/or processed data to a plurality of destinations, including at least one real-time data user 219. The at least one real-time data user 219 may include data sources 222 and 223. In one example, navigation data source 222 includes a vehicle navigation system adapted to provide route planning based on the location of an input destination and environmental factors, such as traffic and weather conditions.

Scheduling data source 223 may include well-known software, such as Microsoft Outlook, which is adapted to communicate with other software applications. Specifically, scheduling software is typically configured to communicate with other instantiations of the same software application in order to plan meetings and coordinate schedules.

In accordance with one embodiment of the invention, decision support system 100 functions as a mediator or middleware application coupling together a plurality of software applications residing on different hosts. In this role, decision support system 100 can adapt meeting times and coordinate schedules in response to external (real-time and/or predicted) events, including the location of each party and travel conditions.

Decision support system may be adapted to dynamically reschedule meetings and appointments in response to local environmental factors that will delay one or more parties from reaching a predetermined meeting place. In one embodiment of the invention, decision support system 100 first evaluates the traffic, weather, and road conditions to generate an initial estimated time of arrival (ETA). Decision support system 100 advantageously factors in other data, such as the availability of parking spaces near the planned destination, to update the ETA. If a delay is anticipated, decision support system 100 checks the availability of each meeting participant for minor schedule changes. Similarly, the early arrival of meeting participants may trigger a schedule “push forward.”

Thus, decision support system 100 performs a many-to-many operation by processing a plurality of data-type inputs and then dynamically routing the data (or derivatives thereof) based on data type and user context. Conversely, to employ such functionality at the client side of the scheduling application would require providing extraordinarily large bandwidth to the real-time data user 219 and enabling substantial data-filtering capabilities at the client scheduling application.

In accordance with another embodiment of this invention, each destination (e.g., user 219) is associated with a predetermined data type and/or data range for data that is to be routed to that user. For example, if user 219 is designated as a motorist that requests weather information that affects driving conditions, precipitation occurring along the motorist's planned driving route qualifies as an evaluation metric that triggers a routing event to that user 219. Various embodiments of the invention may develop evaluation metrics based on any combination of situational awareness, forecasting capabilities, and context awareness.

In a further exemplary embodiment of the invention, a routing event is triggered when the temperature falls below freezing while the road is wet at the motorist's location. In this example, a combination of data types (road conditions, air temperature, and the motorist's location) is used to determine an evaluation metric. For each data type, an evaluation metric is established (road conditions: dry/wet, and temperature: above/below freezing) for the motorist's location or anticipated location. A particular combination of evaluation metrics (wet road conditions and temperature below freezing) is deemed to be relevant with respect to the user's context designation as a motorist in a predetermined geographical location. Depending on the type of data (and the metric(s) upon which the data is evaluated), the data may be routed to predetermined user applications (e.g., navigation 222 and/or scheduling 223). Severe weather and adverse road conditions may warrant an update to a motorist's onboard navigation system 222. However, router embodiments of the invention may override such updates if the user context indicates a high motivation for reaching their destination in a timely manner.

Other embodiments of this invention may employ strategic forecast planning. For example, a motorist's driving route may be modified in response to anticipated local weather conditions. Thus, the intensity of storm cells may be monitored and traffic re-routed in order to avoid potentially dangerous conditions, such as large hail or downed power lines.

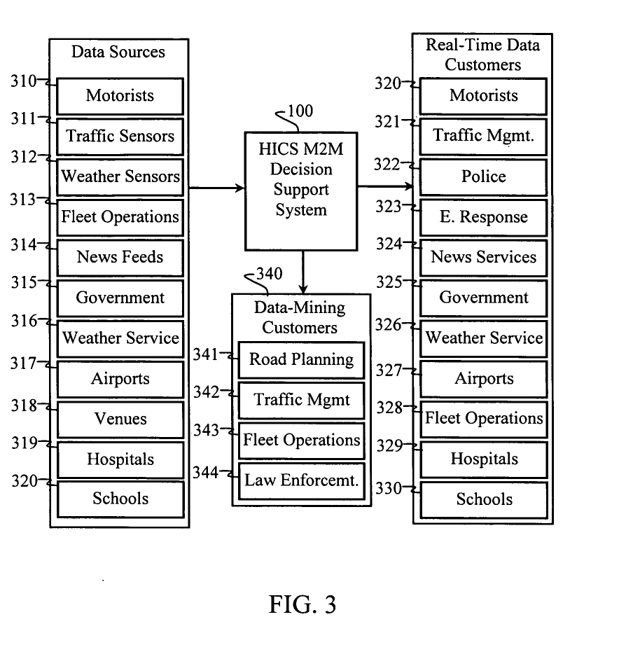

FIG. 3 illustrates a HICS M2M decision support system 100 corresponding to an apparatus and method embodiment of the invention. Decision support system 100 is configured to receive data from a plurality of data sources (such as data sources 310-320) and route data (and advantageously, control information) to a plurality of destination (e.g., real-time data customers 320-330). Furthermore, decision support system 100 may be adapted to route data to at least one data-mining customer, such as customers 341-344.

In another embodiment of the invention, decision support system 100 is provided with situational awareness of at least some of the real-time data customers 320-330. As used herein, “situational awareness” refers to knowledge of activities and events occurring around a user that may impact the user's activities. Situational awareness typically requires knowledge about a particular user's immediate environment, including (but not limited to) the relative geographical location of other users, personnel, vehicles, weather events, road conditions, etc. Situational awareness may also employ dynamic information about a user, such as velocity, mechanical information about a user's vehicle, the user's intended route and destination, etc.

Situational awareness may also be utilized to facilitate interaction and cooperation between users. In accordance with one example, decision support system 100 instructs each motorist in a busy intersection where to move in order to clear a path for emergency-response vehicles. Similarly, decision support system 100, when coupled to onboard vehicle-navigation systems, dynamically redirects traffic away from the routes and destinations of emergency-response vehicles.

Situational awareness in decision support system 100 enhances motorist safety. For example, decision support system 100 may warn a motorist of adverse events or conditions, such as an approaching police chase, flooding at an underpass, an accident, or large pot holes in the street. Situational awareness adds a significant convenience value and safety margin to motorists

In accordance with another embodiment of the invention, decision support system 100 adapts navigational routing for motorists due to special events (e.g., parades, festivals, street cleaning, etc.) that result in temporary street closures. These and other embodiments of the present invention differentiate themselves from well-known news broadcasting services by selectively routing data to particular users based on the relevance of that data for those users. Geographical relevance is only one of the factors that may be employed in the routing decision. Many different factors, including situational awareness, may be employed to route the data.

In still yet another exemplary embodiment of the invention, decision support system 100 is provided with forecasting capabilities relative to at least some of the real-time data customers 320-330. In this case, forecasting capabilities include logical means (such as relational algorithms or deductive algorithms employing statistical analysis) for anticipating future events. Accordingly, forecasting capabilities may advantageously include a response means to provide a warning to a customer, to instruct the customer to take evasive actions, and/or passively influence the outcome of a particular event, such as by controlling traffic signals. Thus, accurate targeted forecasting capabilities rely on a high degree of situational awareness.

Such forecasting capabilities allow decision support system 100 to warn motorists of changing weather and road conditions. For example, in one embodiment of the invention, decision support system 100 collects local temperature data (from weather sensors 312) and local road condition data (from traffic/road sensors 311). Decision support system 100 tracks the rate at which the temperature is dropping and correlates it with the user's route and the current road conditions. A warning is sent to a motorist if the combination of wet roads and below-freezing temperature coincides with the motorist's planned route. Similarly, forecasting capabilities associated with a preferred embodiment of the invention may track storm cells and warn and/or adjust traffic routes accordingly. This type of system differentiates itself from well-known weather forecasting systems in its ability to provide highly localized information, correlate multiple sources of information (e.g., weather and road data), and route the data to specific users based on data format and content. Furthermore, embodiments of the invention may employ a wide range of data sources, data types, and forecast criteria.

In still yet another exemplary embodiment of this invention, decision support system 100 employs context awareness relative to at least some of the real-time data customers 320-330. A recent definition of context awareness is in Dey, A. K. & Abowd, G. D., “Towards a better understanding of context and context-awareness,” GVU Technical Report GIT-GVU-99-22, College of Computing, Georgia Institute of Technology, which is incorporated herein by reference in its entirety. In this reference, “context awareness” is defined as “any information that can be used to characterize the situation of an entity, where an entity can be a person, place, physical or computational object.” “Context awareness” (also called “context-aware computing”) is further defined as “the use of context to provide task-relevant information and/or services to a user, wherever they may be.”

Decision support system 100 receives as inputs raw data (e.g., sensor data), generic data (e.g., news feeds and other broadcast data/media content), and user-specific profile data. Decision support system 100 then processes the raw and generic data sets relative to the subscriber data and then produces a formatted output that is specific to each user. The formatting is specific to user preferences, as well as the type of network the user employs to receive data. For example, a user on the way to the airport may receive updated flight information, local weather conditions, local forecasts, traffic reports, and local news stories about the airport or locations along the planned route. While the user is mobile, the information may be audio. If the user is stopped at a light and there is high-bandwidth capability, the information may be delivered via video. Thus, where the user is going, user preferences, where the user is at any given moment, and what connectivity is available to the user are conditions employed by decision support system 100 to select, format, and deliver information.

While many embodiments of the invention disclosed herein pertain to end-user applications, further embodiments of the invention may be configured to serve data-gathering and news-broadcasting organizations as well. For example, a local news and weather station might be provided with micro-scale reports about which streets are flooded, locations of downed power lines, where hail damage is significant, and which neighborhoods can expect severe weather. This type of information, in addition to ACN and automobile GPS information, may be processed and then distributed to a local transportation authority.

Embodiments of the invention can be particularly useful in establishing highly diverse sensor networks coordinated with advanced decision-support methodologies, such as context-aware and multi-objective genetic algorithms. The term “diversity,” as used herein with reference to data, means that the data is collected with respect to a wide range of at least one set of measurement criteria that is typically reflected in the collected data values. For example, temperature data usually varies with respect to the geographic locations at which the temperature is measured. Thus, diversity in a sensor network can be achieved by collecting and processing information from a large number of geographically distributed sensors.

Furthermore, diversity may be achieved by correlating different information types, such as weather with traffic with cellular phone use. This introduces many possible data-mining applications by introducing additional degrees of freedom in how the data can be interpreted. Therefore, decision support system 100 functions as a dynamic knowledge management system when it is configured to filter and format diverse data appropriately with respect to individual users.

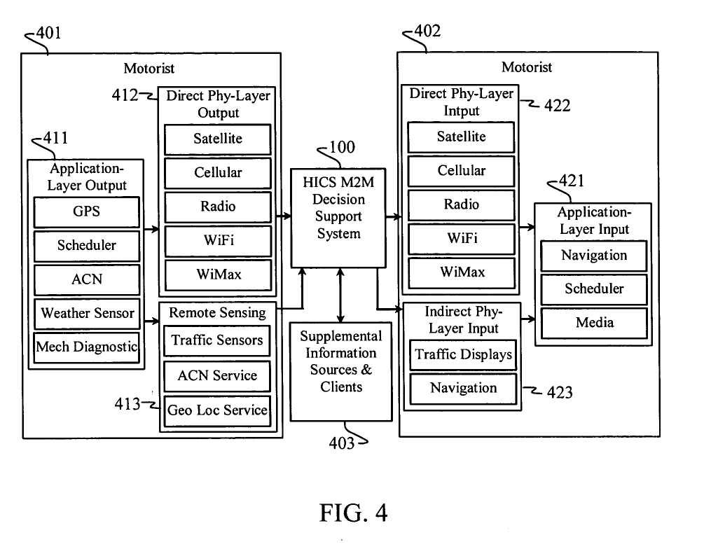

FIG. 4 illustrates an HICS M2M decision support system 100 configured to serve a plurality of subscribers (i.e., users), such as motorist 401 and motorist 402. Decision support system 100 is coupled to a plurality of physical-layer outputs, a plurality of remote-sensing outputs (such as physical-layer output 412 and remote sensing output 413, both of which are associated with motorist 401) or both. Decision support system 100 is also coupled to a plurality of physical-layer inputs (such as direct physical-layer input 422 and indirect input 423, both of which are associated with motorist 402). The physical-layer outputs and the physical-layer inputs may be referred to as physical-layer interfaces.

The couplings of decision support system 100 to the subscribers (e.g., motorists 401 and 402) provide a communicative coupling means between subscriber software applications and decision support system 100. Advantageously, such couplings provide connectivity and interoperability between different subscribers' applications. Furthermore, decision support system 100 may optionally be adapted to supplemental information sources and clients 403.

In a further exemplary embodiment of the invention, one or more subscriber (e.g., motorist 401) software applications (not shown) include an application-layer output (e.g., application-layer output 411) coupled to at least one of the physical-layer output 412 and the remote sensing output 413. Thus, data from a subscriber's software applications and/or instruments (e.g., GPS data, Microsoft Outlook data, ACN data, sensor data, mechanical diagnostic data, etc.) are communicated directly or indirectly to decision support system 100. These software applications and/or output devices (e.g., media devices, user warning systems, and the like) include an application-layer input 421 coupled to the direct physical-layer input 422 and/or the indirect input 423. This coupling enables information from decision support system 100 (and optionally, data from other subscribers) to be used as input to software applications and as output to devices associated with each subscriber (e.g., motorist 402).

Decision support system 100 receives as input raw data (e.g., sensor data), generic broadcast data (e.g., news feeds and other broadcast data/media content), and user-specific profile data. Decision support system 100 processes raw and generic broadcast data relative to the subscriber data and then produces a formatted output that is specific to each user. The formatting is specific to user preferences as well as the type of network the user employs to receive data.

In still another exemplary embodiment of this invention, a motorist on the way to an airport receives flight information, local weather conditions, local forecasts, traffic reports, and local news stories about the airport or locations along the planned route. Customized traffic reports targeted to a particular motorist may be processed from GPS and ACN data originating from other motorists along the planned route to the airport. Weather conditions and forecasts may be derived from a combination of local weather sensors and regional weather forecasts. Pertinent flight information may be cross-referenced with a motorist's ETA. This information may be used to automatically re-route the motorist, reserve a later flight, or notify another party of the motorist's ETA. Similarly, this information may be utilized by an airport authority or an airline operations center to expedite traveler check-in and security screening, hold flights, or book passengers on alternative flights.

Application-layer output 411 for a particular user provides decision support system 100 with some situational awareness and a limited degree of context awareness. A greater degree of situational awareness can be achieved by decision support system 100 when it processes data from nearby users, local sensor networks, and other localized information sources. Context awareness is typically achieved by including a combination of user preferences, application-layer data specifically associated with that user, other user inputs, application-layer data associated with nearby users, and other local information sources. Forecast capabilities advantageously employ situational awareness and context awareness in predictive algorithms to anticipate future events and predict their impact.

Decision support system 100 adapts data collection and disbursement operations relative to the physical-layer interfaces available to each user. When multiple physical-layer interfaces are available, decision support system 100 selects a particular interface to employ based on business rules. For example, decision support system 100 prioritizes data to be delivered to each user. Thus, fee-based communication services (e.g., cellular or wireless subscriber internet services) may be employed for conveying only high-priority data.

In general, decision support system 100 is configured to determine the availability of physical-layer interfaces for each user and select one or more interfaces based on a combination of user preferences, information format (e.g., voice, data, media), and information content. Similarly, decision support system 100 may be adapted to select one of a plurality of networks relative to user location, local channel conditions, and subscriber fees. Thus, access via a Wi-Fi hot spot, for example, may be preferred over a subscription-based internet service as a mode for conveying information due to both bandwidth and cost metrics. Access to different networks typically changes with user mobility. Thus, the process of maintaining a physical-layer connection is usually dynamic.

One exemplary embodiment of decision support system 100 is preferably configured to perform session management to ensure session continuity as the user migrates between networks. Embodiments of the invention may optionally provide for consolidated billing services when the physical layer spans a plurality of fee-based networks so that the user is provided with a single bill for services.

Decision support system 100 may optionally employ context awareness as a means for selecting physical-layer interfaces for each user. While the user is mobile, decision support system 100 employs an audio communications link and formats the data accordingly. If the user has high-bandwidth capability while stopped at a traffic light, the information may be delivered via video. Thus, certain embodiments of decision support system 100 may be adapted to format and deliver data based on user context awareness.

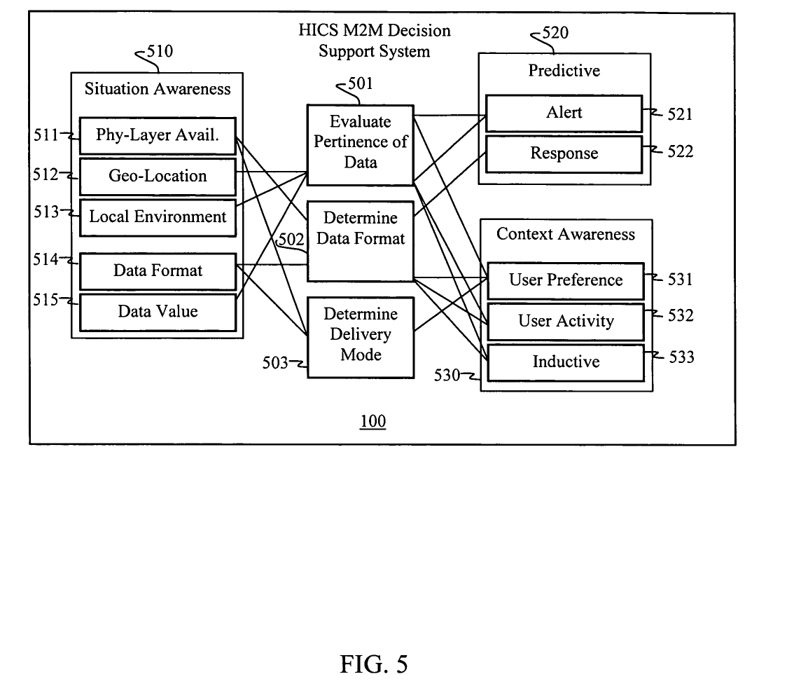

FIG. 5 illustrates a functional embodiment of an HICS M2M decision support system, such as decision support system 100 shown in FIGS. 1-4. Decision support system 100 is adapted to collect data from a plurality of data sources and then disburse the data to a plurality of destinations (i.e., users). The disbursed data may include raw data, processed data, control messages or a combination thereof, based directly or indirectly on the received data. Decision support system 100 evaluates the pertinence of received data 501 with respect to each of a plurality of users. Data that is pertinent to particular users is either further processed or forwarded directly to those users. Thus, decision support system 100 may be adapted to analyze the content of received data and make routing decisions based on the content. The data format to be conveyed to users is determined 502 relative to one or more criteria, including the type of data received and how the data will be presented to the user. A delivery mode for transmitted data is determined 503 prior to disbursing the data.

The step of evaluating the pertinence of received data 501 with respect to each user is performed with the assistance of algorithms adapted to provide decision support system 100 with at least one of situational awareness 510, predictive capabilities 520, and context awareness 530. For example, the relevance of data to a particular user depends on the user's location 512 and the user's immediate environment. Furthermore, the data values may be compared to a predetermined or dynamic relevance threshold with respect to each user depending on that user's local situation or environment. The pertinence of received data 501 may also depend on a user's alert-notification status or on intervention directives sent to (or received from) the user.

Similarly, the step of evaluating the pertinence of received data 501 may include providing user alerts 521 and/or response 522. A user alert may include a warning about icy road conditions, whereas a response could include a navigation system update intended to avoid a dangerous situation. Furthermore, evaluating the pertinence of received data 501 can be influenced by context awareness 530 of the user.

User preferences 531 (e.g., information that the user is interested in, how the user wants to be notified, how often the user wants to be notified, etc.) are used to determine which data is relevant, as well as what data ranges are relevant. Information about what a user is doing 532 (e.g., driving on a highway, sitting in traffic, headed toward the beach, going to a business meeting, etc.) is used to determine what kind of data is pertinent to the user's activity. Inductive algorithms 533 that estimate a user's state of mind (e.g., tired, happy, ill, etc.) can be useful for determining what data is pertinent to the user as well as how to adapt service to the user. Similarly, deductive algorithms (not shown) may be used to estimate a user's state of mind and associate types of data that are likely to be relevant to the user's activities.

Advantageously, the data format selected by decision support system 100 also depends on situational awareness 510, such as the received data format 514 and what physical-layer connection options are available 511 to a particular user. For example, broadband connections allow for streaming media, whereas narrowband connections (e.g., IS-95 cellular) may require data to be formatted as a text message. Similarly, context awareness 530 may be a factor in determining the data format 502. For example, a user's activity 532 (e.g., driving a car) and/or user preferences 531 may restrict the data format 514 and/or the delivery mode 503.

The response 522 protocol in a predictive algorithm 520 may include providing a navigation system update, in which case, the data format is configured to be compatible with that expected by the navigation system. Determining the data format 502 may further include data-processing algorithms or functions (such as filtering, averaging, extrapolation, estimation, distilling, summarizing, correlating, decision processing, pattern matching, statistical analysis, etc.), such as to provide processed data, which is then disbursed to selected users.

Data routing involves determining the delivery mode 503, which typically includes selecting specific physical-layer connections by which the data is transmitted to the users. For example, direct physical-layer communication links to a user may be provided via one or more communication networks, including satellite, cellular, AM/FM radio broadcast, local area (e.g., Wi-Fi), and wide-area (e.g., Wi-Max) networks. Such physical-layer connections are typically used to convey information directly to a user. Furthermore, decision support system 100 may employ communication links to passive information-distribution systems, including roadside traffic information displays.

Decision support system 100 may optionally transmit data in the form of control information to traffic-control devices (e.g., traffic signals). Thus, rather than routing the data directly to a user, the data may be employed by an external control system configured to invoke a predetermined response from the system. Similarly, embodiments of the invention may convey information to electronic user devices (e.g., navigation systems) to invoke a predetermined response from the user. Preferred embodiments of decision support system 100 may provide any combination of indirect communications (e.g., information transfer to devices that a user responds to) and direct communication (e.g., user notification). User preferences may establish at least some of the parameters used to control communications. For example, a motorist may wish not to be informed every time that traffic is slowing. However, the motorist may wish to be informed about route changes made in response to traffic or weather conditions.

The availability of physical-layer connections 511 and the data format 514 are typically considered when determining the delivery mode 503. Various business rules may be employed as well. For example, decision support system 100 may seek communication links to the user that are optimized with respect to cost, as well as the type of information being conveyed. Data deemed to be of particular importance may be transmitted over high-priority channels (e.g., channels having larger bandwidth, higher quality of service, and or higher subscription fees). Another factor that can be closely related to business rules is the consideration of user preferences 531 in the determination of delivery mode 503.

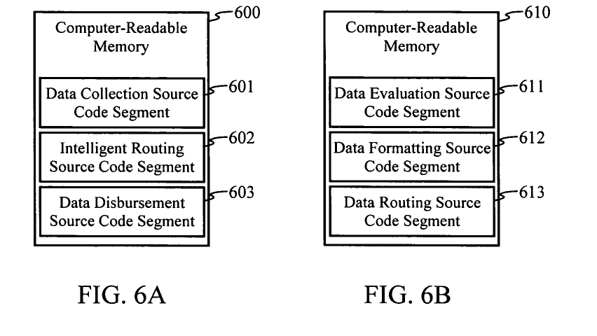

FIG. 6A illustrates a software embodiment of the invention wherein a data collection source code segment 601, an intelligent routing source code segment 602, and a data disbursement source code segment 603 reside on a computer-readable memory 600. The data collection source code segment 601 is configured to collect data from a plurality of data sources. The data may include a plurality of data formats. Thus, the data collection source code segment 601 may optionally be adapted to convert collected data into a common data format. The intelligent routing source code segment 602 is adapted to evaluate the received data and route the data to predetermined destinations based on the data evaluation. For example, routing decisions may be based on combinations of data values, correlations between data values, derivatives of data values, and the like. Resulting evaluations may be compared to set threshold values that can be used to trigger a predetermined response, such as a user notification or a navigation system update.

The data disbursement source code segment 603 is configured to format data assigned for routing to at least one predetermined destination. Formatting is typically performed with respect to the data type and/or how the data will be used at the at least one predetermined destination.

FIG. 6B illustrates a software embodiment of the invention wherein a data evaluation source code segment 611, a data formatting source code segment 612, and a data routing source code segment 613 reside on at least one computer-readable memory 610. The data evaluation source code segment 611 is adapted to receive data collected from a plurality of data sources. Accordingly, the data evaluation source code segment 611 may optionally be preceded by a data-collection source code segment (not shown). The data evaluation source code segment 611 is configured to evaluate collected data as part of a process for determining what data is relevant to which of a plurality of users.

In one exemplary embodiment of the invention, data evaluation 611 includes analyzing data attributes (e.g., data values, correlations between data values, values of processed data, etc.) to identify pertinent data, and then determining which users will be recipients of the data based on one or more user attributes (e.g., situational awareness, context awareness, etc.). In another aspect of the invention, data evaluation 611 is initiated by predetermined data filters configured to select data with respect to predetermined user attributes. The data evaluation source code segment 611 may include data-processing algorithms, such as described previously. Thus, data evaluated by source code segment 611 may comprise processed data.

The data formatting source code segment 612 is adapted to condition data for at least one predetermined user application. For example, weather data that is pertinent to a particular user may be derived from a variety of weather sensors. However, the data is preferably formatted to be more useful to the user. Thus, the sensor data could be processed to generate a weather map display or a printed or graphical warning message. Alternatively, the data formatting source code segment 612 may process the weather information to provide a navigation system update. Thus, the weather data may be formatted as control data for a navigation system. The data formatting source code segment 612 may optionally format the data for a particular communication link selected for communicating with the user or a user application.

Data routing source code segment 613 is configured to select appropriate communication links for conveying data to predetermined users. Selection of the communication links may depend on any combination of factors, including (but not limited to) the type of data, channel bandwidth, data and/or user priority, user preferences, data format, required quality of service, cost of communication resources, and channel conditions. Thus, the data routing source code segment 613 may be configured to employ various user-aware parameters, including situational awareness and context awareness. Similarly, the data routing source code segment 613 may employ network-aware and/or channel-aware parameters. For example, the data routing source code segment 613 may be adapted to provide optimal routing paths given the network configuration, link reliabilities, and network load. In peer-to-peer and ad-hoc networks, the data routing source code segment 613 may employ routing tables that are centrally located or distributed across multiple nodes (e.g., mobile terminals).

The source-code segments 611-613 may be configured to operate in any order. The sequential order of the source-code segments 611-613 described previously is only one of several software embodiments of the invention. Alternative embodiments of the invention may employ parallel functions and/or alternative sequential orders. For example, adverse weather conditions may restrict which communication link is selected by the data routing source code segment 613. A change in the anticipated communication link may require the data formatting source code segment 612 to reformat the data. Also, impaired channel conditions may limit the amount of data that can be sent to a particular user. Thus, the data evaluation source code segment 611 may be called upon to select which data is most pertinent to the user based on given channel constraints.

The preceding descriptions merely illustrate specific embodiments of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents, as well as equivalents developed in the future, i.e., any elements developed that perform the same function, regardless of structure.

Thus, for example, it will be appreciated by those skilled in the art that the block diagrams shown herein represent conceptual views of illustrative circuitry embodying the principles of the invention. Similarly, it will be appreciated that any flow charts, flow diagrams, and the like represent various processes which may be substantially represented in computer-readable medium and so executed by a computer or processor, whether or not such computer or processor is explicitly shown.

The functions of the various elements shown in the drawings, including functional blocks, may be provided through the use of dedicated hardware, as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. The function of illustrated hardware components may be carried out through the operation of program logic, through dedicated logic, through the interaction of program control and dedicated logic, the particular technique being selectable by the implementer as more specifically understood from the context.

1. A many-to-many (M2M) hazard information coordination system comprising:
a. a plurality of data collectors adapted to provide input data,
b. a plurality of data disbursers, and
c. a decision support system coupling said plurality of data collectors to said plurality of data disbursers, said decision support system including a data-evaluation module adapted to evaluate the input data to produce at least one data evaluation and a routing module adapted to route the input data to at least one of said plurality of data disbursers with respect to the at least one data evaluation.

2. The M2M hazard information coordination system recited in claim 1 wherein said decision support system is adapted to generate at least one data-bearing message from the input data for distribution to at least a subset of said plurality of data disbursers.

3. The M2M hazard information coordination system recited in claim 1 wherein said decision support system is adapted to perform at least one data-processing operation on the input data.

4. The M2M hazard information coordination system recited in claim 1 wherein said decision support system is adapted to employ at least one relevance estimation function configured to estimate how relevant certain input data is to particular recipients.

5. The M2M hazard information coordination system recited in claim 1 wherein said decision support system is adapted to provide for conditioning the data for commercial distribution.

6. The M2M hazard information coordination system recited in claim 1 wherein said plurality of data collectors includes at least one of at least one local data source and at least one regional data source.

7. The M2M hazard information coordination system recited in claim 1 wherein said plurality of data disbursers includes at least one of data distribution service providers, client-side systems, public-notification systems, and traffic-control devices.

8. The M2M hazard information coordination system recited in claim 1 wherein said plurality of data collectors includes at least one of a traffic data source, a weather data source, a road conditions data source, and at least one user input.

9. The M2M hazard information coordination system recited in claim 1 wherein said plurality of data disbursers includes at least one user terminal and at least one data miner.

10. The M2M hazard information coordination system recited in claim 1 wherein said decision support system is configured to interface between a plurality of software applications residing on different hosts.

11. The M2M hazard information coordination system recited in claim 1 wherein at least one of said plurality of data collectors and said plurality of data disbursers includes a plurality of physical-layer interfaces, and said decision support system being configured to select at least one of the plurality of physical-layer interfaces based on business rules.

12. The M2M hazard information coordination system recited in claim 1 wherein at least said plurality of data collectors includes at least a first application-layer interface and said plurality of data disbursers include at least a second application-layer interface, and said decision support system being configured to facilitate information transfers between said first application-layer interface and said second application-layer interface.

13. The M2M hazard information coordination system recited in claim 1 wherein said decision support system is configured to produce the at least one data evaluation and route the input data to at least one of said plurality of data disbursers with respect to at least one of situational awareness, forecasting, and context awareness.

14. The M2M hazard information coordination system recited in claim 1 wherein said decision support system is configured to format the input data with respect to at least one of user preference and network type.

15. The M2M hazard information coordination system recited in claim 1 wherein said decision support system is configured to perform at least one of session management and consolidated billing.

16. The M2M hazard information coordination system recited in claim 1 wherein said decision support system is configured to perform data processing prior to producing the at least one data evaluation.

17. A many-to-many (M2M) hazard information coordination system comprising:
a. a plurality of scheduling software applications residing on a plurality of host platforms,
b. a plurality of external data sources capable of characterizing a local environment for at least one user, and
c. a decision support system adapted to function as a middleware application between said plurality of scheduling software applications, said decision support system coupled to said plurality of external data sources and configured to coordinate scheduling between said plurality of scheduling software applications in response to anticipated schedule changes derived from data collected from said plurality of external data sources.

18. The M2M hazard information coordination system recited in claim 17 wherein at least one of said plurality of scheduling software applications includes Microsoft Outlook.

19. The M2M hazard information coordination system recited in claim 17 wherein said decision support system is adapted to generate at least one estimated time of arrival for at least one user.

20. The M2M hazard information coordination system recited in claim 17 wherein said decision support system is adapted to analyze the content of the data collected from said plurality of external data sources and make routing decisions based on the content.

21. A method of intelligent routing employing data evaluation to effect said intelligent routing, the method comprising:
a. providing for collecting data from a plurality of data sources to produce collected data, the collected data characterized by a plurality of data types,
b. providing for evaluating the collected data to produce at least one evaluation metric for at least one of the plurality of data types, and
c. providing for making at least one routing decision to route the collected data to each of a plurality of destinations, said at least one routing decision being made relative to at least one of the plurality of data types and the at least one evaluation metric.

22. The method of intelligent routing recited in claim 21 wherein providing for evaluating the collected data to produce at least one evaluation metric includes producing the at least one evaluation metric with respect to at least one of situational awareness, forecasting, and context awareness.

23. The method of intelligent routing recited in claim 21 wherein at least one of providing for evaluating the collected data and providing for making at least one routing decision includes providing for processing the collected data to produce processed data, the step of providing for making at least one routing decision being adapted to route the processed data to at least one of a plurality of destinations.

24. The method of intelligent routing recited in claim 21 wherein providing for making at least one routing decision includes strategic forecast planning.

25. The method of intelligent routing recited in claim 21 wherein providing for making a routing decision includes routing the collected data to at least one of a data distribution service provider, a client-side system, a public-notification system, and a traffic-control device.

26. The method of intelligent routing recited in claim 21 wherein the plurality of data sources includes at least one of a traffic data source, a weather data source, a road conditions data source, and a user input.

27. The method of intelligent routing recited in claim 21 further comprising providing for an interface between a plurality of software applications residing on different hosts.

28. The method of intelligent routing recited in claim 21 further comprising providing for formatting the collected data with respect to at least one of user preference and network type.

29. The method of intelligent routing recited in claim 21 further comprising providing for at least one of session management and consolidated billing.

30. A computer program residing on a computer-readable medium for providing for intelligent routing in an M2M system, the computer program comprising:
a. a data collection source code segment configured to collect data from a plurality of data sources to produce received data,
b. an intelligent routing source code segment adapted to evaluate the received data to generate evaluated data, and route the evaluated data to at least one predetermined destination, and
c. a data disbursement source code segment adapted to format the evaluated data.

31. The computer program recited in claim 30 further comprising a routing data collection source code segment configured to collect at least one routing-decision metric.

32. The computer program recited in claim 30 wherein said data collection source code segment is adapted to convert the received data into a common data format.

33. The computer program recited in claim 30 wherein said intelligent routing source code segment is adapted to produce routing decisions based on at least one of values of the received data, correlations between values of the received data, and derivatives of the received data.

34. The computer program recited in claim 30 wherein said intelligent routing source code segment is adapted to perform data processing on at least one of the received data and the evaluated data.

35. The computer program recited in claim 30 wherein said intelligent routing source code segment includes algorithms for providing at least one of situational awareness, forecasting, and context awareness.

36. The computer program recited in claim 30 wherein said data disbursement source code segment is adapted to format the evaluated data with respect to at least one of user preference and network type.

37. A computer program residing on a computer-readable medium for providing for intelligent routing in an M2M system, the computer program comprising:
a. a data evaluation source code segment configured to evaluate collected data for producing evaluated data as part of a process for determining what data is relevant to which of a plurality of users,
b. a data formatting source code segment configured to format the evaluated data to produce formatted data for at least one predetermined user application, and
c. a data routing source code segment configured to select at least one communication link for conveying the formatted data to the plurality of users

38. The computer program recited in claim 37 further comprising a message delivery data collection source code segment configured to collect at least one message delivery metric.

39. The computer program recited in claim 37 further comprising a data collection source code segment adapted to produce the collected data.

40. The computer program recited in claim 37 wherein said data evaluation source code segment is configured to process at least one of the collected data and the evaluated data.

41. The computer program recited in claim 37 wherein said data evaluation source code segment is configured to select at least one of the collected data and the evaluated data with respect to predetermined user attributes.

42. The computer program recited in claim 37 wherein said data routing source code segment is configured to select the at least one communication link relative to at least one parameter, including data type, channel bandwidth, data priority, user priority, user preference, data format, quality of service, cost of communication resources, and channel conditions.

43. The computer program recited in claim 37 wherein at least one of said data evaluation source code segment, said data formatting source code segment, and said data routing source code segment is configured to provide for at least one of situational awareness, forecasting, and context awareness.
